(19) United States
(12) Patent Application Publication
(10) Pub. No.: US 2015/0188201 A1
(43) Pub. Date: Jul. 2, 2015

(54) BATTERY MODULE

(71) Applicants: UER Technology (SHENZHEN) LIMITED, Shenzhen (CN); UER Technology Corporation, Miaoli County (TW)

(72) Inventors: RAY-TANG SUN, Miaoli (TW); TSUNG-HSIEN CHUANG, Miaoli (TW); CHENG-GHI FANG, Miaoli (TW); WEN-HSIEN CHEN, Miaoli (TW)

(21) Appl. No.: 14/573,261

(22) Filed: Dec. 17, 2014

(30) Foreign Application Priority Data
Dec. 31, 2013 (TW) 102149360

(51) Int. Cl. H01M 10/613; H01M 10/656; H01M 10/42; H01M 2/10; H01M 6/50; H01M 10/6552

(52) U.S. Cl. CPC H01M 10/5004; H01M 6/5011; H01M 6/5038; H01M 10/5048; H01M 10/4207; H01M 2/1016; H01M 10/5061

(57) ABSTRACT

A battery module includes a base, a battery assembly supported by the base and comprising one or more battery cells, and a heat dissipation unit for dissipating heat created by the one or more battery cells. The heat dissipation unit comprises one or more heat-conducting elements to transmit the heat from the one or more battery cells. Each of the one or more heat-conducting elements comprises a plurality of branches concentrated at a substantially middle portion to form a fixing portion and extend away from each other at two ends of each branch. Each of the one or more battery cells is in contact with the branches of at least one of the one or more heat-conducting elements.

### CROSS-REFERENCE TO RELATED APPLICATIONS

This application is related co-pending U.S. patent applications of Attorney Docket No. US5,4737, US54738, and US54740, each entitled “BATTERY MODULE”, and each invented by Sun et al. These applications have the same assignee as the present application. The above-identified applications are incorporated herein by reference.

### FIELD

The present disclosure relates to a battery module including a plurality of battery cells.

### BACKGROUND

A lot of heat can be created during use of a battery module comprising a plurality of battery cells. Effective heat dissipation is needed for the battery module.

### BRIEF DESCRIPTION OF THE DRAWINGS

Implementations of the present technology will now be described, by way of example only, with reference to the attached figures.

FIG. 1 is an exploded, isometric view of a battery module according to an exemplary embodiment.

FIG. 2 is a partially exploded, isometric view of the battery module of FIG. 1.

FIG. 3 is an assembled, isometric view of the battery module of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

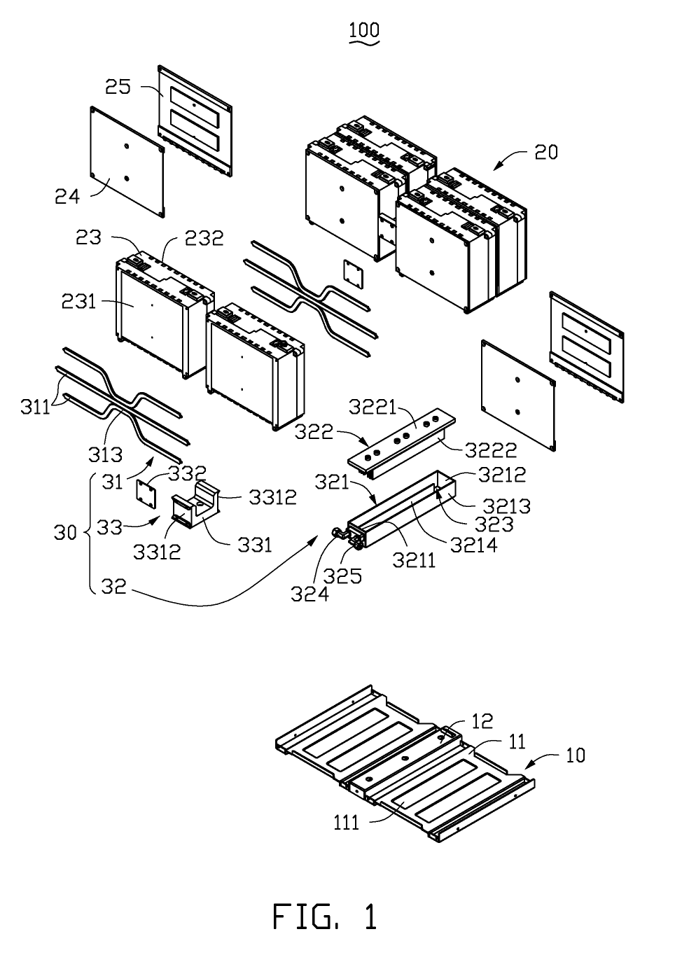

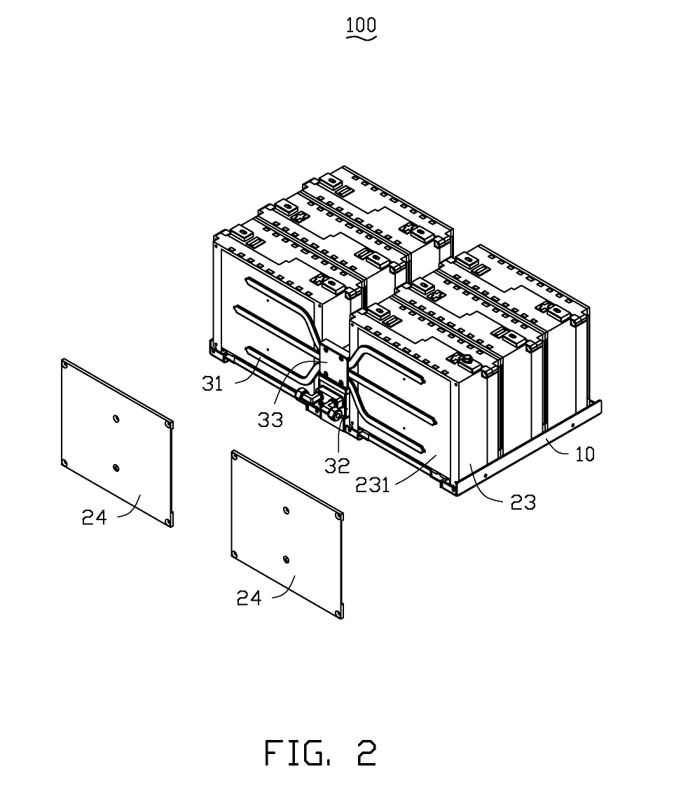

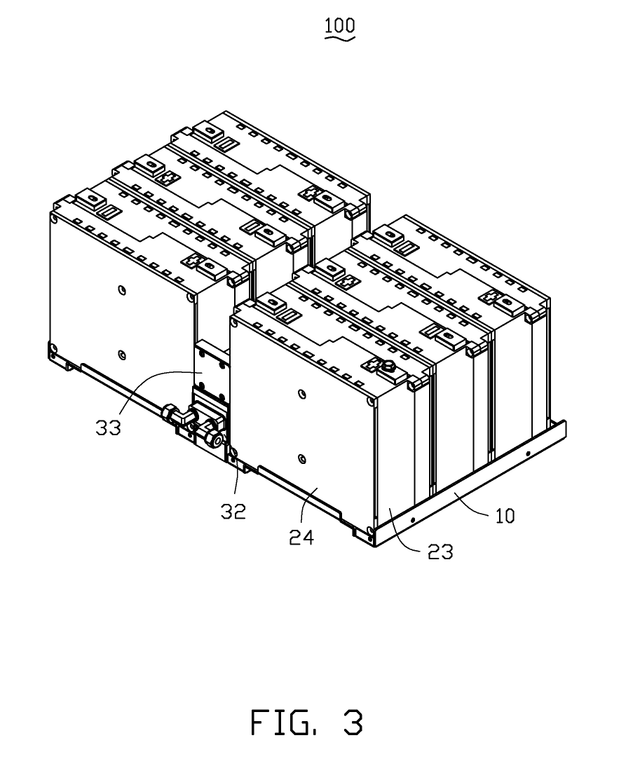

FIG. 1 through FIG. 3 illustrate a battery module 100 comprising a base 10, a battery assembly 20 supported by the base 10, and a heat dissipation unit 30 for dissipating heat created by the battery assembly 20. The battery assembly 20 comprises one or more battery cells 23. The heat dissipation 30 comprises one or more heat-conducting elements 31. The one or more heat-conducting elements 31 are configured to transmit the heat from the one or more battery cells 23. Each battery cell 23 is in contact with at least one of the one or more heat-conducting elements 31.

Each heat-conducting element 31 comprises a plurality of branches 311 extending substantially in the same plane. Each branch 311 can be strip-shaped. The branches 311 concentrate at a substantially middle portion to form a fixing portion 313 and extend away from each other at two ends of each branch 311. Each of the one or more battery cells 23 is in contact with the branches 311 of at least one of the one or more heat-conducting elements 31. In at least one embodiment, the branches 311 are heat pipes which are configured to transfer heat between two solid interfaces.

The base 10 is configured to secure and support the battery assembly 20 and the heat dissipation unit 30. The base 10 comprises a first support portion 11 for supporting the battery assembly 20 and a second support portion 12 for supporting the heat dissipation unit 30. The second support portion 12 is located at a substantially middle portion of the first support portion 11. In at least one embodiment, the second support portion 12 is substantially bar-shaped and protrudes from the first support portion 11.

In at least one embodiment, the battery assembly 20 comprises a plurality of battery cells 23, and the battery cells 23 are arranged in a matrix. In at least one embodiment, the plurality of battery cells 23 are arranged in a matrix having two columns and three rows. In other embodiments, the numbers of the rows and the columns can be varied. The battery cells 23 of the same one column are arranged one adjacent to another. In the exemplary embodiment, each row of the battery cells 23 have two corresponding heat-conducting elements 31 positioned at two opposite sides with the branches 311 in contact with two opposite side surfaces 231, 232 of each battery cell 23 of the row.

Each of the one or more battery cells 23 can further have a front cover 24 and a back cover 25 attached to the two opposite side surfaces 231, 232 to cover the branches 311.

The heat dissipation unit 30 further comprises a cooling box 32 and one or more connecting elements 33. The cooling box 32 is configured to radiate heat transmitted by the one or more heat-conducting elements 31. The cooling box 32 defines an interior space 323 to accommodate a cooling fluid, an inlet 324 to feed the cooling fluid into the interior space 323, and an outlet 325 to discharge the cooling fluid from the interior space 323, thereby allowing a circulation of the cooling fluid in the cooling box 32. The one or more heat-conducting elements 31 are connected to the cooling box 32 through the one or more connecting elements 33.

In at least one embodiment, the cooling box 32 comprises a main body 321 defining the interior space 323 and a cover 322. The main body 321 comprises a first end wall 3211, a second end wall 3212 opposite to the first end wall 3211, and two side walls 3213 connected to the first and second end walls 3211, 3212. The first end wall 3211, the second end wall 3212, and the two side walls 3213 surround the interior space 323. The first end wall 3211 defines the inlet 324 and the outlet 325. The inlet 324 and the outlet 325 each can be connected to a pipe, thereby allowing a circulation of the cooling fluid in the cooling box 32.

The cooling box 32 can further comprise a baffle 3214 positioned in the interior space 323. The baffle 3214 is connected to a portion of the first end wall 3211 located between the inlet 324 and the outlet 325 and extends towards the second end wall 3211. An end of the baffle 3214 away from the first end wall 3211 is spaced from the second end wall 3211. The baffle 3214 can lengthen a running path of the cooling fluid in the cooling box 32, causing enough contact between the cooling fluid and the cooling box 32 to facilitate removal of heat transmitted by the one or more heat-conducting elements 31, thereby improving heat dissipation efficiency.

The cover 322 covers on the main body 321 to close the interior space 323. The cover 322 comprises a cover board 3221 and a plurality of fins 3222 connected to a surface of the cover board 3221 facing the interior space 323. The fins 3222 are substantially parallel to each other and are substantially parallel to the baffle 3214. The fins 3222 extend in the interior space 323 and are located at two sides of the baffle 3214 when the cover 322 covers on the main body 321. The cover board 3221 and the fins 3222 can be made of high heat-conductive material. In at least one embodiment, the cover board 3221 and the fins 3222 are made of the same material and are integrally formed together. The fins 3222 are configured to divide the cooling fluid in the interior space 323 into divisional streams, allowing even heat dissipation of the cooling box 32 and improved the heat dissipation efficiency.

The one or more connecting elements 33 are configured to connect the one or more heat-conducting elements 31 to the cooling box 32. A number of the connecting elements 33 can be equal to a number of the rows of the battery cell matrix. Each connecting element 33 comprises a connecting block 331 and two fastening boards 332. The connecting block 331 defines two locking notches 3312 in two opposite ends. In at least one embodiment, each locking notch 3312 is defined by two flange portions protruding from a top edge and a bottom edge of the connecting block 331. The two fastening boards 332 are configured to fix the one or more heat-conducting elements 31 to the connecting block 331 by holding the fixing portion 313 in the locking notches 3312.

To assemble the battery module 100, the main body 321 is secured to the second support portion 12. The cover 322 is covered on the main body 321 and the fins 3222 extend into the interior space 323. One connecting block 331 is then secured to a surface of the cover 322 opposite to the fins 3222. A first row of the battery cells 23 is positioned on the first support portion 11 with the battery cells 23 of the first row located at two sides of the connecting block 331. One heat-conducting element 31 is positioned at each side of the first row of the battery cells 23, with the fixing portion 313 of each heat-conducting element 31 locked in the locking notches 3312 by one of the fastening board 332, and the branches 311 of each heat-conducting element 31 are in contact with the two sides surfaces 231, 232 of the battery cells 23. The front covers 24 and the back covers 25 are then attached to the two side surfaces 231, 232 of each battery cell 23 to cover the branches 311. The other rows of battery cells 23 are assembled by a similar manner.

In use, the inlet 324 is connected to a feeding pipe and the outlet 325 is connected to a discharge pipe. A cooling fluid can be fed into the interior space 323 and flows in the interior space 323. Heat created by the battery cells 23 are conducted by the one or more heat-conducting elements 31 to the one or more connecting elements 33, and then transmitted to the cooling box 32 by the one or more connecting elements 33. The cooling fluid in the cooling box 32 takes away the heat, thereby dissipating the heat created by the battery cells 23.

The embodiments shown and described above are only examples. Many details are often found in the art such as the other features of a battery module. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A battery module comprising:
a base;
a battery assembly supported by the base, the batter assembly comprising one or more battery cells; and
a heat dissipation unit for dissipating heat created by the one or more battery cells;
wherein the heat dissipation unit comprises one or more heat-conducting elements to transmit the heat from the one or more battery cells, each of the one or more heat-conducting elements comprises a plurality of branches concentrated at a substantially middle portion to form a fixing portion and extend away from each other at two ends of each branch, each of the one or more battery cells is in contact with the branches of at least one of the one or more heat-conducting elements.

2. The battery module of claim 1, wherein when the batter assembly comprises a plurality of battery cells, the plurality of battery cells are arranged in a matrix; each row of the battery cells has two corresponding heat-conducting elements positioned at two opposite sides with the branches in contact with two opposite side surfaces of each battery cell of the row.

3. The battery module of claim 2, wherein the branches are heat pipes.

4. The battery module of claim 1, wherein the heat dissipation unit further comprises a cooling box and one or more connecting elements; the one or more connecting elements connect the one or more heat-conducting elements to transmit the created by the one or more battery cells to the cooling box to be dissipated.

5. The battery module of claim 1, wherein the plurality of branches extend substantially in the same plane.

6. The battery module of claim 5, wherein each of the plurality of branches is strip-shaped.
